(19) United States
(12) Patent Application Publication
(10) Pub. No.: US 2019/0164526 A1
(43) Pub. Date: May 30, 2019

(54) HANGING DEVICE

(71) Applicant: Tatsuro MIYATAKE, Fuchu-shi (JP)

(72) Inventor: Tatsuro MIYATAKE, Fuchu-shi (JP)

(21) Appl. No.: 16/143,801

(22) Filed: Sep. 27, 2018

(30) Foreign Application Priority Data
Nov. 30, 2017 (CN) 201711240677.2

(51) Int. Cl. G10G 5/00; G10D 7/08; G10D 9/00

(52) U.S. Cl. CPC G10G 5/005; G10D 9/00; G10D 7/08

(57) ABSTRACT

The present invention provides a hanging device, characterized in that the hanging device comprises a hanging portion, a first wearing portion, and a second wearing portion, the first wearing portion comprising a neck strap, the neck strap comprising a neck strap front portion and a neck strap rear portion, and the second wearing portion comprising back straps, the back strap comprising a back strap front portion and a back strap rear portion, wherein the back strap front portion is connected to the neck strap front portion, and the back strap rear portion is connected to the neck strap rear portion.

### CROSS REFERENCE TO RELATED APPLICATION

This application claims priority of Chinese Application No. 201711240677.2, filed Nov. 30, 2017, the contents of which are incorporated herein by reference.

### BACKGROUND

The present invention relates to a hanging device, and in particular, to a hanging device for musical instruments like saxophones, clarinets, and the like.

Western musical instruments, such as saxophones, clarinets, and the like, are liked by many music fans. With regard to these wind instruments, it demands a lot of physical strength from players after a long period of playing due to the weight of the musical instruments. Therefore, sling-type hanging devices that hang a musical instrument by means of a sling on the neck of a player, as shown in FIG. 7, or back-strap type hanging devices that hang a musical instrument by a back strap worn by a player on the upper body thereof, as shown in FIG. 8, exist.

With regard to the above sling-type hanging device, however, a player can easily feel sore at the cervical vertebra as the full weight of a musical instrument is applied on the cervical vertebra of the player.

With regard to the above back-strap type hanging device, on the other hand, the weight of a musical instrument is not applied on the cervical vertebra of a player, but the position where it supports the musical instrument is relatively low, making it difficult to achieve a support effect that is sufficient and makes the player feel comfortable. In addition, it is impossible to freely move the musical instrument when this type of back-strap type hanging device is used. Furthermore, the back-strap type hanging device does not have a length adjuster, making it impossible to adjust the length freely, or even when a length adjuster is installed, the use is inconvenient because it is necessary to adjust lengths of both the longitudinal shoulder strap and the horizontal chest strap thereof. Furthermore, the back-strap type hanging device sometimes cannot be used when a player is putting on a suit, and therefore it does not look aesthetically pleasing.

### SUMMARY

The present invention is obtained in light of the above problems, and the objective of the present invention is to provide a support method that can greatly reduce the burden on a player's neck and can support a hung heavy object, such as a musical instrument, in a sufficient and comfortable manner.

A hanging device according to the present invention is characterized in that the hanging device comprises a hanging portion, a first wearing portion, and a second wearing portion, the first wearing portion comprising a neck strap, the neck strap comprising a neck strap front portion and a neck strap rear portion, and the second wearing portion comprising back straps, the back strap comprising a back strap front portion and a back strap rear portion, wherein the back strap front portion is connected to the neck strap front portion, and the back strap rear portion is connected to the neck strap rear portion.

When the hanging device according to the present invention is used to support a hung heavy object, such as a musical instrument, the support points can be evenly distributed over all parts of the body of the person who wears the hanging device, such that it can support the hung heavy object, such as a musical instrument, in a sufficient and comfortable manner, and in particular can greatly reduce the burden on a player's neck.

The hanging device according to the present invention can also be that the first wearing portion further comprises a neck strap length adjusting portion capable of adjusting the length of the neck strap; and/or the second wearing portion further comprises a back strap length adjusting portion capable of adjusting the length of the back strap.

In the hanging device according to the present invention, the use length of the hanging device can be adjusted by adjusting the length of the neck strap and/or the back strap. Moreover, the back strap rear portion can be pulled downwardly by adjusting the length of the back straps, so as to reduce the burden on a user during use. The length adjustment is mainly completed by adjusting the length of the back strap, while the adjustment of the length of the neck strap is simply a secondary means. Compared with the existing back-strap type hanging devices, the adjustment manner is much simpler.

The hanging device according to the present invention can also be that the neck strap length adjusting portion and/or the back strap length adjusting portion is a [symbol] -shaped adjustment buckle or a lace-up structure.

In the hanging device according to the present invention, the neck strap length adjusting portion and/or the back strap length adjusting portion is a [symbol] -shaped adjustment buckle or a lace-up structure, such that these length adjusting portions have a simple structure and are easy to use.

The hanging device according to the present invention can also be that the hanging device further comprises a connection portion through which the back strap front portion is connected to the neck strap front portion, the connection portion is provided with the hanging portion, the neck strap is a strap with ends, the two ends thereof jointly forming the neck strap front portion, the neck strap front portion being connected to the connection portion, respectively, and/or the back strap is a strap with ends, the two ends thereof jointly forming the back strap front portion, the back strap front portion being connected to the connection portion, respectively.

In the hanging device according to the present invention, by connecting the back strap front portion to the neck strap front portion through the connection portion, the connecting positions of the first wearing portion and the second wearing portion in the front of a body are all at the connection portion. As a result, the connecting ends of the neck strap and the back strap require simple processing, which leads to good processability.

The hanging device according to the present invention can also be that, between the neck strap front portion and the back strap front portion, the neck strap rear portion and the back strap rear portion, the neck strap front portion and the connection portion, and the back strap front portion and the connection portion, at least one is removable.

In the hanging device according to the present invention, all parts are relatively removable, thereby facilitating a combined use of the first wearing portion and the second wearing portion or the use of only the first wearing portion. As a result, the use is flexible.

The hanging device according to the present invention can also be that the hanging portion comprises a moving member, the moving member being connected to the back strap front portion in a manner that it can be guided by the back strap front portion to move.

In the hanging device according to the present invention, the moving member can be made to move relative to the back strap front portion, such that the hook for hanging a heavy object, such as a saxophone, can be moved freely from side to side and the use is convenient.

The hanging device according to the present invention can also be that the back strap front portion comprises a pants connecting portion capable of being connected to pants or a belt of a user.

In the hanging device according to the present invention, by connecting the back strap front portion to pants or a belt of a user, the user can select what to wear according to actual situations. Therefore, the hanging device can be used even when a suit is worn, and does not affect the beautiful appearance.

The hanging device according to the present invention can also be that the connecting portion has a certain lateral width.

In the hanging device according to the present invention, the connecting portion has a certain lateral width such that the angle of the neck strap front portion relative to the vertical direction decreases, thereby dispersing the force acting on the neck of a user and reducing the burden on the user during use.

The hanging device according to the present invention can also be that the connecting portion is made of a hard material.

In the hanging device according to the present invention, the connecting portion is made of a hard material, which can lead to a roughly constant use circumference of the neck strap, thereby preventing the circumference of the neck strap from decreasing due to the deformation of the connecting portion that causes a burden on the user.

The hanging device according to the present invention can also be that the connecting portion is either Y shaped or X shaped; when the connecting portion is Y shaped, the two top ends thereof are connected to the two ends of the neck strap front portion, respectively, and the bottom end thereof is simultaneously connected to the two ends of the back strap front portion; when the connecting portion is X shaped, the two top ends thereof are connected to the two ends of the neck strap front portion, respectively, and the two bottom end thereof are connected to the two ends of the back strap front portion, respectively.

In the hanging device according to the present invention, the connecting portion is either Y shaped or X shaped, such that the connecting portion has a smaller volume and better effect of visual design; moreover, the force acting on the neck of a user can be dispersed and the burden on the user is thereof reduced during use.

Moreover, when the Y-shaped connecting portion is used, the connecting portion can be lowered just by pressing the cross point of two sides of the Y-shaped connecting portion with one finger, and the connecting portion can be raised by pressing and lifting the bottom edges of two sides of the Y-shaped connecting portion with two fingers. Therefore, the Y-shaped connecting portion can easily raise and lower the connecting portion.

In addition, when the Y-shaped connecting portion is used and its bottom end is connected to the moving member, the hanging rope or the neck strap front portion and the back strap front portion connected to the Y-shaped connecting portion can be effectively tensioned in three directions, thereby forming a stable support for the side to side movement of the hung musical instrument.

The hanging device according to the present invention can also be that the neck strap and/or the back strap have a certain width.

In the hanging device according to the present invention, the neck strap and/or the back strap have a certain width, which can disperse the force acting on a user and reduce the burden on the user during use.

The hanging device according to the present invention can also be that the neck strap is padded.

In the hanging device according to the present invention, the neck strap is padded, which can reduce the burden on the neck and shoulders of a user, and can alleviate muscle soreness when the hanging device is used for a long period of time.

The hanging device according to the present invention can also be that the connection portion further functions as the neck strap length adjusting portion.

In the hanging device according to the present invention, the neck strap length adjusting portion further functions as the connection portion, which can easily adjust the hanging length of the hanging device.

The hanging device according to the present invention can greatly reduce the burden on the neck of a player and can be used when a suit is worn without affecting the beautiful appearance.

### BRIEF DESCRIPTION OF THE DRAWINGS

FIG. 1 is a front view of the hanging device according to the present invention in a state of being worn by a user.

FIG. 2 is a front view of the hanging device according to the present invention in a state of not being worn by a user.

FIG. 3 is a rear view of the hanging device according to the present invention in a state of being worn by a user, which also indicates different use modes of the back strap.

FIG. 4 is a front view of another example of the hanging device according to the present invention in a state of being worn by a user.

FIG. 5 is a front view of another example of the hanging device according to the present invention in a state that only the first wearing portion is worn by a user.

FIG. 6 is a front view of another example of the hanging device according to the present invention in a state of being worn by a user.

FIG. 7 is a diagram of an existing sling-type hanging device.

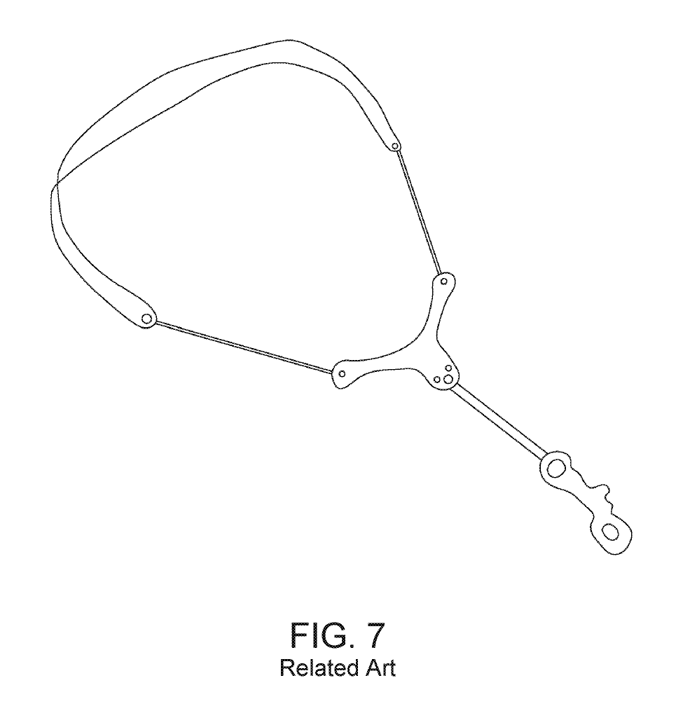

FIG. 8 is a diagram of an existing back-strap type hanging device.

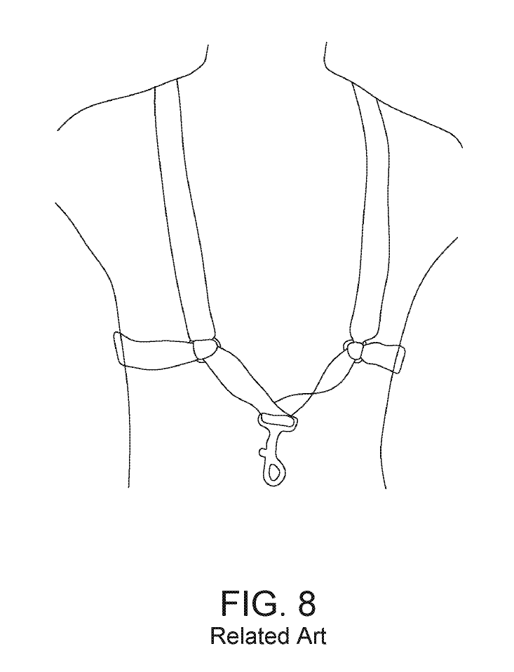

### EXPLANATION OF THE LEGENDS

100. hanging device
1. first wearing portion
11. neck strap
12. through hole
13. hanging rope
14. connection portion
15. Pad
16. end hole
17. middle hole
2. second wearing portion
21. back strap
22. hanging rope
23. hanging rope
24. adjusting buckle
25. hanging hook
3. ring member
4. hanging hook

### DETAILED DESCRIPTION OF EMBODIMENTS

The hanging device according to the present invention will be described below with reference to the accompanying drawings. In addition, the side in front of a user is referred to as front, the side behind the user is referred to as rear, the left and right direction of the front of the user is used as left and right direction in the present invention, and the up and down direction of the front of the user is used as up and down direction in the present invention.

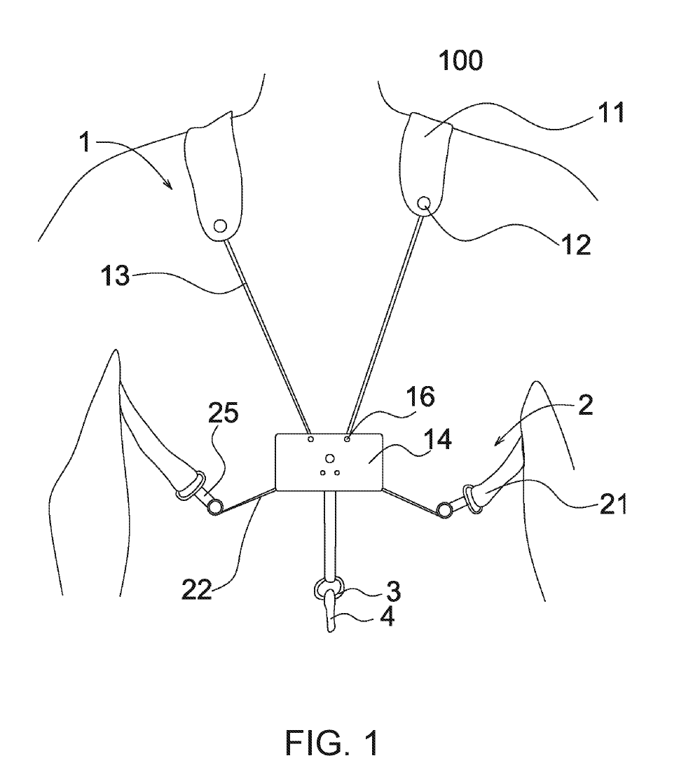

As shown in FIG. 1, a hanging device 100 according to the present invention comprises a hanging portion, a first wearing portion 1, and a second wearing portion 2.

The first wearing portion 1 comprises a neck strap 11 that is placed on the neck of a user during use, and through holes 12 are formed on the two front ends thereof, respectively. The neck strap 11 is divided into a neck strap front portion disposed at the front of a body when the neck strap is placed on the neck and a neck strap rear portion at the rear of a body when the neck strap is placed on the neck.

The hanging device 100 according to the present invention further comprises a connection portion 14 for connecting the second wearing portion 2 with the first wearing portion 1, which will be described in detail below. The connection portion 14 is a rectangle having a certain width laterally, end holes 16 are formed at the top two ends and bottom two ends of the rectangle, and a middle hole 17 is formed at the center of the rectangle. The connection portion 14 is provided with the hanging portion mentioned above, and the hanging portion comprises a ring member 3 and a hook 4 connected to the ring member 3 and for hanging a saxophone. The ring member 3 corresponds to the moving member set forth in the technical solution. In the following other embodiments, the ring member 3 can achieve movement in the left and right direction. A hanging rope 13 is used to connect the neck strap 11, the connection portion 14, and the hook 4. Specifically, one end of the hanging rope 13 is connected to a through hole 12 at one end of the neck strap 11, and the other end thereof is connected to a through hole 12 at the other end of the neck strap 11 after going through the end holes 16, the middle hole 17, and the ring member 3 of the connection portion 14, thereby connecting the neck strap 11, the connection portion 14, and the hook 4 in a removable manner. Therefore, a simple structure can be used to achieve length adjustment for the first wearing portion 1 in the running-through connection manner of the hanging rope 13.

When only the first wearing portion and the connection portion are assembled, the hanging device can be used as a sling-type hanging device according to the prior art.

The second wearing portion 2 comprises two back straps 21, and all ends of the two back straps are provided with a connection member, such as a hook. The back strap 21 is divided into a back strap front portion disposed at the front of a body when the back strap is worn and a back strap rear portion at the rear of a body when the back strap is worn. A hanging rope 22 is used to connect the front end of the back strap 21, i.e., the back strap front portion, to the front end of the neck strap 11, i.e., the neck strap front portion, via the connection portion 14 and the hanging rope 13, and to connect the rear end of the back strap 21, i.e., the back strap rear portion, to the rear end of the neck strap 11, i.e., the neck strap rear portion, such that the first wearing portion and the second wearing portion can be combined for use as a back-strap type hanging device. Specifically, two hanging ropes are used to connect the two ends of the back straps 21 at the rear during use to the rear portion of the neck strap 11, respectively, and two hanging ropes are used to connect the two ends of the back straps 21 at the front during use to the bottom two ends of the connection portion 14.

In the first wearing portion 1, the hanging rope 13 is connected to a through hole 12 of the neck strap 11 in a lace-up manner, thereby enabling the adjustment of the use length of the hanging rope 13 and the adjustment of the use length of the first wearing portion 1. In addition, the neck strap 11 can also be provided with a [symbol] -shaped adjustment buckle for adjusting the use length of the neck strap, which can also adjust the use length of the first wearing portion 1.

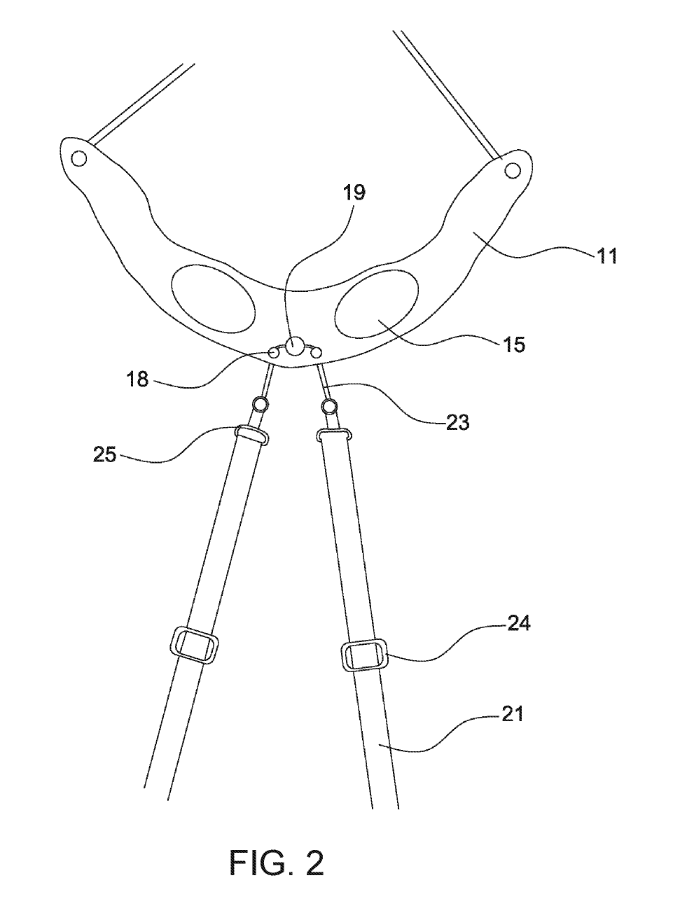

As shown in FIG. 2, moreover, the back straps 21 of the second wearing portion 2 are also provided with a [symbol] -shaped adjustment buckle for adjusting the length of the back straps 21. In addition, the length of the back straps 21 can also be adjusted by adjusting the length of the hanging rope of the second wearing portion 2. By adjusting the length of the back straps 21, the rear portion of the neck strap 11 can be pulled downwardly, which can greatly reduce the force applied on the neck and reduce the burden on the neck.

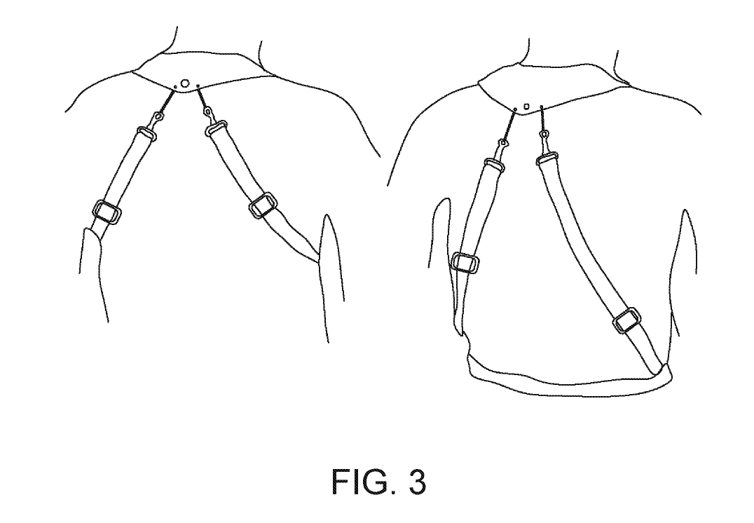

As shown in FIG. 3, moreover, the two ends of the back straps 21 that are connected to each other can be not connected, but instead, they can be connected to pants or a belt of a user, respectively. In such a circumstance, the hanging device not only can be used as a sling-type hanging device, but also can pull the back strap rear portion downwardly by adjusting the length of the back straps, thereby greatly reducing the burden on a neck. In such a circumstance, moreover, the hanging device can also be used even when a suit is worn without affecting the beautiful appearance.

Furthermore, the connection between the neck strap 11 and the back strap 21, the neck strap 11 and the connection portion 14, the back strap 21 and the connection portion 14, or the back strap 21 and the pants or belt of the user is removable, and therefore, it is easy to switch the use modes of the hanging device.

The hanging device according to the present invention is not limited to the above modes of implementation, but can also have the following variations.

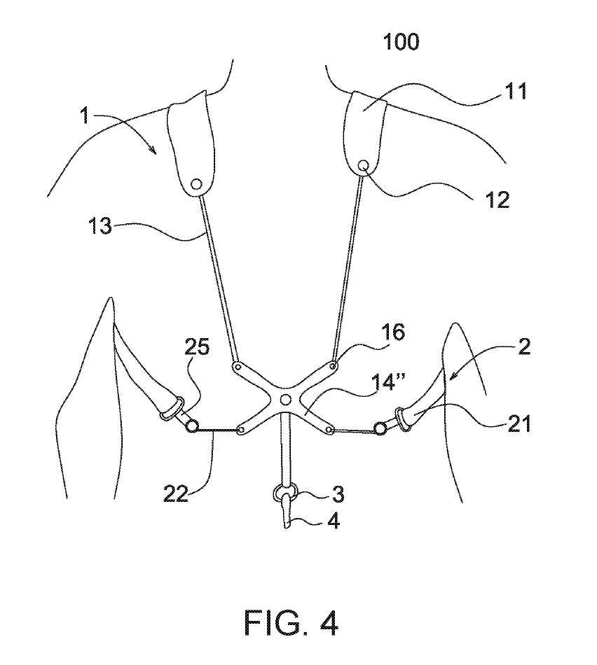

In addition, FIG. 4 illustrates another example of the connection portion. The connection portion 14″ is X shaped, end holes are formed at four ends of the branches of the X shape, respectively, and a middle hole is formed in the center of the X shape. This example can achieve the same effect as that of the above connection portion 14″, and compared with the above connection portion 14″, has a smaller volume, is easier to use, and achieves a better effect of visual design.

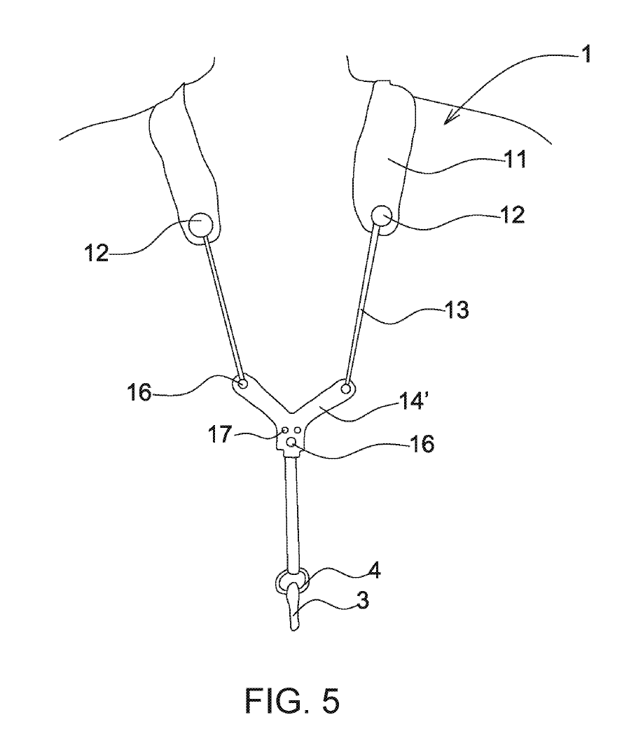

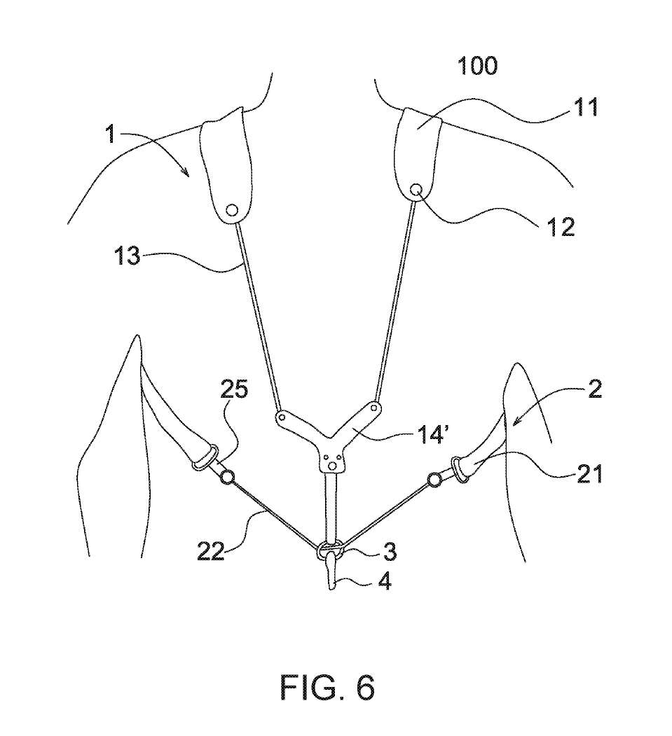

FIGS. 5 and 6 illustrate yet another example of the connection portion. The connection portion 14′ is Y shaped, end holes are formed at two ends of the fork and the other end of the Y shape, respectively, and a middle hole is formed in the center of the Y shape. It is similar as the above that a hanging rope is used to connect the neck strap 11, the connection portion 14′, and the hanging portion.

When the connection portion is set to be Y shaped, to lower the connecting portion, one finger can be used to press downwardly the cross point of two sides of the Y-shaped connecting portion and the connecting portion will be lowered. To raise the connecting portion, two fingers can be used to press and lift the bottom edges of two sides of the Y-shaped connecting portion, and then the connecting portion can be raised. Therefore, the adoption of the Y-shaped connecting portion can easily raise and lower the connecting portion.

In addition, when the Y-shaped connecting portion is used and its bottom end is connected to the moving member, the hanging rope or the neck strap front portion and the back strap front portion connected to the Y-shaped connecting portion can be effectively tensioned in three directions, thereby forming a stable support for the side to side movement of the hung musical instrument.

Furthermore, in this embodiment, the connection is slightly different for the first wearing portion 1 and the second wearing portion 2. Specifically, two hanging ropes 23 are used to connect the two ends of the back straps 21 at the rear during use to the rear portion of the neck strap 11, and one hanging rope 22 is used to connect the two ends of the back straps 21 at the front during use by going through the above ring member 3.

As shown in FIG. 6, therefore, the first wearing portion 1 and the second wearing portion 2 are combined to a back-strap type hanging device for use. When the first wearing portion 1 and the second wearing portion 2 are combined in use, the hanging rope 22 connects the two front ends of the two back straps 21 by going through the ring member 3, and therefore the ring member 3 can move relative to the front portions of the back straps 21 as guided by the hanging rope 22, thereby enabling the hook for hooking a musical instrument to move left and right freely. As a result, a musical instrument that can be hung by the hanging portion can move freely without being restricted by the back straps.

The connection portion according to the present invention is not limited by the above several examples, and can be any shape as long as it can reduce the burden on a user. In addition, the neck strap can be padded to reduce the burden on the neck and shoulders of a user and to alleviate muscle soreness when the hanging device is used for a long period of time.

Moreover, the user can also adjust the use length of the first wearing portion 1 and the hanging length to hang a saxophone by adjusting the winding length of the hanging rope at the connection portion 14. In such a circumstance, the connection portion 14 also functions as the neck strap length adjusting portion.

In the hanging device according to the present invention, moreover, the number of the neck strap and the back strap is not limited. According to the need, there can be one neck strap and one back strap, or the neck strap and the back strap can be formed by connecting a plurality of straps, or a plurality of straps can be connected at the ends to form one strap. In addition, the hanging device according to the present invention is not limited to only hang a musical instrument, such as saxophone, clarinet, and the like, but also can hang heavy objects, such as speakers, baby pouches, and the like, as needed.

In the hanging device according to the present invention, moreover, the hanging portion can be provided at any position of the hanging device, as long as it is convenient for hanging. According to different purposes, the hanging portion can be provided either in the front of a body or behind the body. For example, the hanging portion can be provided in the front of the body when hanging a musical instrument, and can be provided behind the body when hanging a speaker, a heavy object, and the like.

In the hanging device according to the present invention, moreover, two ends of the neck strap 11, i.e., the neck strap front portion, are connected to the back strap front portion via the connection portion and the hanging rope 13 that are separately provided, and two rear ends of the back strap 21, i.e., the back strap rear portion, are connected to the neck strap rear portion via the hanging ropes 23; however, the neck strap front portion can also be directly connected to the back strap front portion, and the back strap rear portion can also be directly connected to the neck strap rear portion. The hanging portion can be either provided at the connection point where the neck strap front portion and the back strap front portion are connected or provided at a position of the neck strap front portion or the back strap front portion.

In the hanging device according to the present invention, moreover, the neck strap front portion, i.e., two ends of the neck strap 11, being connected to the connection portion means either that the two ends can be directly connected to the connection portion 14 or that the two ends can be combined into one and then connected to the connection portion, or the neck strap front portion can be connected to the connection portion via the hanging rope 13 as shown in the implementation mode.

In the hanging device according to the present invention, moreover, the ring member 3 is used as the moving member, but a hook-shaped member can also be used, where two ends of the hook-shaped member are pressed against each other via a pretightening force to form a ring. In addition, a moving member in other modes, such as a zipper, can also be used, and it is not limited to the manner in which a moving member like the ring member 3 moves on the hanging rope 22. When the back strap 21 has a proper width, the moving member like the ring member 3 can also move on the back strap front portion that is an integral piece by directly connecting the front ends of the back strap 21, as long as the moving member can move along the back strap front portion.

Several specific examples of the present invention are described above, which merely illustrate a part of the present invention, instead of limiting the claims. The technologies according to the claims comprise technical solutions obtained after various variations and modifications made to the specific examples illustrated above. The present description or the technical features according to the accompanying drawings achieve, independently or through various combinations thereof, the technical applicability, and are not limited to the combinations stated in the claims at the time of application filing. In addition, the present description or technologies illustrated in the accompanying drawings simultaneously achieve multiple technical objectives, while the achievement of one of the technical objectives itself possesses the technical applicability.

What is claimed is:

1. A hanging device comprising:
a hanging portion;
a first wearing portion including a neck strap having a neck strap front portion and a neck strap rear portion; and
a second wearing portion including a back strap, the back strap including a back strap front portion and a back strap rear portion, wherein the back strap front portion is connected to the neck strap front portion, and the back strap rear portion is connected to the neck strap rear portion.

2. The hanging device according to claim 1, wherein the first wearing portion includes a neck strap length adjusting portion configured to adjust the length of the neck strap.

3. The hanging device according to claim 2, wherein the neck strap length adjusting portion has an adjustment buckle or a lace-up structure.

4. The hanging device according to claim 1, further comprising:
a connection portion through which the back strap front portion is connected to the neck strap front portion, the connection portion being provided together with the hanging portion, wherein
the neck strap includes two ends jointly forming the neck strap front portion, the neck strap front portion being connected to the connection portion.

5. The hanging device according to claim 4, wherein at least one of (i) a connection between the neck strap front portion and the back strap front portion, (ii) a connection between the neck strap rear portion and the back strap rear portion, (iii) a connection between the neck strap front portion and the connection portion, and (iv) a connection between the back strap front portion and the connection portion, is detachable.

6. The hanging device according to claim 5, wherein the hanging portion includes a moving member connected to the back strap front portion, the moving member being configured to be guided by the back strap front portion.

7. The hanging device according to claim 6, wherein the back strap front portion includes a pants connecting portion configured to be connected to pants or a belt of a user.

8. The hanging device according to claim 4, wherein the connection portion has a Y shape with three ends, two of the three ends of the connection portion are connected to the two ends of the neck strap, and a third end of the connection portion is connected to two ends of the back strap front portion.

9. The hanging device according to claim 1, wherein the neck strap is padded.

10. The hanging device according to claim 4, wherein the connection portion is configured to adjust the length of the neck strap.

11. The hanging device according to claim 1, wherein the second wearing portion includes a back strap length adjusting portion configured to adjust the length of the back strap.

12. The hanging device according to claim 11, wherein the back strap length adjusting portion has an adjustment buckle or a lace-up structure.

13. The hanging device according to claim 1, further comprising:
a connection portion through which the back strap front portion is connected to the neck strap front portion, the connection portion being provided together with the hanging portion, wherein
the back strap includes two ends jointly forming the back strap front portion, the back strap front portion being connected to the connection portion.

14. The hanging device according to claim 4, wherein the connection portion has an X shape with four ends, two of the four ends of the connection portion are connected to the two ends of the neck strap, and the remaining two of the four ends of the connection portion are connected to two ends of the back strap front portion.
